(19) United States
(12) Patent Application Publication
(10) Pub. No.: US 2025/0254229 A1
(43) Pub. Date: Aug. 7, 2025

(54) METHOD, APPARATUS AND COMPUTER PROGRAM

(71) Applicant: Nokia Technologies Oy, Espoo (FI)

(72) Inventors: Srinivas GARIKIPATI, Bangalore (IN); Bruno LANDAIS, Lannion (FR)

(21) Appl. No.: 19/039,039

(22) Filed: Jan. 28, 2025

(30) Foreign Application Priority Data
Feb. 6, 2024 (GB) 2401554.7

(51) Int. Cl. H04L 67/563; H04L 67/51

(52) U.S. Cl. CPC H04L 67/563; H04L 67/51

(57) ABSTRACT

There is provided an apparatus comprising means for: sending, to a first producer network function, a first service request comprising information indicating a requested service and information identifying a second producer network function that is unable to provide the requested service; and receiving, from the first producer network function, a service response to the first service request.

### TECHNICAL FIELD

Various example embodiments of this disclosure relate to a method, apparatus, system and computer program and in particular but not exclusively to requesting and providing network function (NF) services.

### BACKGROUND

A communication network can be seen as a facility that enables communications between two or more communication devices or provides communication devices access to a data network. A mobile or wireless communication network is one example of a communication network. A communication device may be provided with a service by an application server.

Such communication networks operate in according with standards such as those provided by 3GPP (Third Generation Partnership Project) or ETSI (European Telecommunications Standards Institute). Examples of standards provided by 3GPP are the so-called 3GPP standards for cellular technology generations, such as 3GPP standards for 4G technology and 3GPP standards for 5G technology.

### SUMMARY

Some example embodiments of this disclosure will be described with respect to certain aspects. These aspects are not intended to indicate key or essential features of the embodiments of this disclosure, nor are they intended to be used to limit the scope of thereof. Other features, aspects, and elements will be readily apparent to a person skilled in the art in view of this disclosure.

According to an aspect, there is provided an apparatus comprising means for: sending, to a first producer network function, a first service request comprising information indicating a requested service and information identifying a second producer network function that is unable to provide the requested service; and receiving, from the first producer network function, a service response to the first service request.

The means may be further for: sending, to the second producer network function, a second service request comprising information indicating the requested service; determining that no response to the second service request has been received from the second producer network function within a certain time period; and sending the first service request to the first producer network function in response to determining that no response has been received to the second service request within the certain time period.

The means may be further for: sending, to the second producer network function, a second service request comprising information indicating the requested service; receiving, from the second producer network function, a second service response rejecting the second service request; and sending the first service request to the first producer network function in response to receiving the second service response rejecting the second service request.

The means may be further for: sending, to the second producer network function, a second service request comprising information indicating the requested service; receiving, from the second producer network function, a second service response comprising information indicating that the second service request is to be redirected to the first producer network function; and sending the first service request to the first producer network function in response to receiving the second service response comprising information indicating that the second service request is to be redirected to the first producer network function.

The second service response may comprise information indicating a cause for redirection, and wherein the first service request further comprises the information indicating the cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The means may be further for: determining, based on previously received information, that the second producer network function is unable to provide the requested service; and sending the first service request in response to determining that the second producer network function is unable to provide the requested service.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function; an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect there is provided an apparatus comprising means for: receiving, from a consumer network function, a first service request comprising information indicating a requested service and information identifying a second producer network function that is unable to provide the requested service; determining whether to provide the requested service; and based on the determining, sending, to the consumer network function, a service response to the first service request.

The first service request may further comprise information indicating that the first service request is a request that was transmitted or retransmitted to an alternative producer network function.

The first service request may further comprise information indicating that the second producer network function did not respond, rejected or redirected a second service request for the requested service.

The first service request may further comprise information indicating that the first service request is a redirection request, and wherein the first service request may further comprise information indicating a cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The means may be further for: determining, based on the first service request, to refrain from redirecting the first service request and/or one or more further service requests for the requested service towards the second producer network function.

The means may be further for: receiving the first service request and/or the one or more further service requests for the requested service; determining that the first service request and/or the one or more further service requests are to be redirected away from the first producer network function; and in response to determining to redirect the first service request and/or the one or more further service requests away from the first producer network function and determining to refrain from redirecting the first service request and/or the one or more further service requests towards the second producer network function, discovering one or more candidate producer network functions towards which the first service request and/or the one or more further service requests may be redirected, wherein the one or more candidate producer network functions excludes the second producer network function.

Discovering the one or more candidate producer network functions may comprise: sending, to a network repository function, a discovery request comprising information identifying the requested service and indicating that the second producer network function is to be excluded from a list of candidate producer network functions; and receiving, from the network repository function, a list of candidate producer network functions for providing the requested service, wherein the list of candidate producer network functions excludes the second producer network function.

The information indicating that the second producer network function is to be excluded from a list of candidate producer network functions may comprise at least one of: an identifier of the second producer network function; an identifier of a service instance of the second producer network function; an identifier of a set of producer network functions to which the second producer network function belongs; or an identifier of a set of service instances of the second producer network function.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function; an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect, there is provided an apparatus comprising at least one processor and at least one memory storing instructions that, when executed by the at least one processor, cause the apparatus at least to: send, to a first producer network function, a first service request comprising information indicating a requested service and information identifying a second producer network function that is unable to provide the requested service; and receive, from the first producer network function, a service response to the first service request.

The at least one processor may be further configured to cause the apparatus to: send, to the second producer network function, a second service request comprising information indicating the requested service; determine that no response to the second service request has been received from the second producer network function within a certain time period; and send the first service request to the first producer network function in response to determining that no response has been received to the second service request within the certain time period.

The at least one processor may be further configured to cause the apparatus to: send, to the second producer network function, a second service request comprising information indicating the requested service; receive, from the second producer network function, a second service response rejecting the second service request; and send the first service request to the first producer network function in response to receiving the second service response rejecting the second service request.

The at least one processor may be further configured to cause the apparatus to: send, to the second producer network function, a second service request comprising information indicating the requested service; receive, from the second producer network function, a second service response comprising information indicating that the second service request is to be redirected to the first producer network function; and send the first service request to the first producer network function in response to receiving the second service response comprising information indicating that the second service request is to be redirected to the first producer network function.

The second service response may comprise information indicating a cause for redirection, and wherein the first service request further comprises the information indicating the cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The at least one processor may be further configured to cause the apparatus to: determine, based on previously received information, that the second producer network function is unable to provide the requested service; and send the first service request in response to determining that the second producer network function is unable to provide the requested service.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function; an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect, there is provided an apparatus comprising at least one processor and at least one memory storing instructions that, when executed by the at least one processor, cause the apparatus at least to: receive, from a consumer network function, a first service request comprising information indicating a requested service and information identifying a second producer network function that is unable to provide the requested service; determine whether to provide the requested service; and based on the determining, send, to the consumer network function, a service response to the first service request.

The first service request may further comprise information indicating that the first service request is a request that was transmitted or retransmitted to an alternative producer network function.

The first service request may further comprise information indicating that the second producer network function did not respond, rejected or redirected a second service request for the requested service.

The first service request may further comprise information indicating that the first service request is a redirection request, and wherein the first service request may further comprise information indicating a cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The at least one processor may be further configured to cause the apparatus to: determine, based on the first service request, to refrain from redirecting the first service request and/or one or more further service requests for the requested service towards the second producer network function.

The at least one processor may be further configured to cause the apparatus to: receive the first service request and/or the one or more further service requests for the requested service; determine that the first service request and/or the one or more further service requests are to be redirected away from the first producer network function; and in response to determining to redirect the first service request and/or the one or more further service requests away from the first producer network function and determining to refrain from redirecting the first service request and/or the one or more further service requests towards the second producer network function, discover one or more candidate producer network functions towards which the first service request and/or the one or more further service requests may be redirected, wherein the one or more candidate producer network functions excludes the second producer network function.

The at least one processor may be further configured to cause the apparatus to: send, to a network repository function, a discovery request comprising information identifying the requested service and indicating that the second producer network function is to be excluded from a list of candidate producer network functions; and receive, from the network repository function, a list of candidate producer network functions for providing the requested service, wherein the list of candidate producer network functions excludes the second producer network function.

The information indicating that the second producer network function is to be excluded from a list of candidate producer network functions may comprise at least one of: an identifier of the second producer network function; an identifier of a service instance of the second producer network function; an identifier of a set of producer network functions to which the second producer network function belongs; or an identifier of a set of service instances of the second producer network function.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function; an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect, there is provided a method comprising: sending, to a first producer network function, a first service request comprising information indicating a requested service and information identifying a second producer network function that is unable to provide the requested service; and receiving, from the first producer network function, a service response to the first service request.

The method may further comprise: sending, to the second producer network function, a second service request comprising information indicating the requested service; determining that no response to the second service request has been received from the second producer network function within a certain time period; and sending the first service request to the first producer network function in response to determining that no response has been received to the second service request within the certain time period.

The method may further comprise: sending, to the second producer network function, a second service request comprising information indicating the requested service; receiving, from the second producer network function, a second service response rejecting the second service request; and sending the first service request to the first producer network function in response to receiving the second service response rejecting the second service request.

The method may further comprise: sending, to the second producer network function, a second service request comprising information indicating the requested service; receiving, from the second producer network function, a second service response comprising information indicating that the second service request is to be redirected to the first producer network function; and sending the first service request to the first producer network function in response to receiving the second service response comprising information indicating that the second service request is to be redirected to the first producer network function.

The second service response may comprise information indicating a cause for redirection, and wherein the first service request further comprises the information indicating the cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The method may further comprise: determining, based on previously received information, that the second producer network function is unable to provide the requested service; and sending the first service request in response to determining that the second producer network function is unable to provide the requested service.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function; an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect there is provided a method comprising: receiving, from a consumer network function, a first service request comprising information indicating a requested service and information identifying a second producer network function that is unable to provide the requested service; determining whether to provide the requested service; and based on the determining, sending, to the consumer network function, a service response to the first service request.

The first service request may further comprise information indicating that the first service request is a request that was transmitted or retransmitted to an alternative producer network function.

The first service request may further comprise information indicating that the second producer network function did not respond, rejected or redirected a second service request for the requested service.

The first service request may further comprise information indicating that the first service request is a redirection request, and wherein the first service request may further comprise information indicating a cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The method may further comprise: determining, based on the first service request, to refrain from redirecting the first service request and/or one or more further service requests for the requested service towards the second producer network function.

The method may further comprise: receiving the first service request and/or the one or more further service requests for the requested service; determining that the first service request and/or the one or more further service requests are to be redirected away from the first producer network function; and in response to determining to redirect the first service request and/or the one or more further service requests away from the first producer network function and determining to refrain from redirecting the first service request and/or the one or more further service requests towards the second producer network function, discovering one or more candidate producer network functions towards which the first service request and/or the one or more further service requests may be redirected, wherein the one or more candidate producer network functions excludes the second producer network function.

Discovering the one or more candidate producer network functions may comprise: sending, to a network repository function, a discovery request comprising information identifying the requested service and indicating that the second producer network function is to be excluded from a list of candidate producer network functions; and receiving, from the network repository function, a list of candidate producer network functions for providing the requested service, wherein the list of candidate producer network functions excludes the second producer network function.

The information indicating that the second producer network function is to be excluded from a list of candidate producer network functions may comprise at least one of: an identifier of the second producer network function; an identifier of a service instance of the second producer network function; an identifier of a set of producer network functions to which the second producer network function belongs; or an identifier of a set of service instances of the second producer network function.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function;

an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect, there is provided a computer readable medium comprising instructions which, when executed by an apparatus, cause the apparatus to perform at least the following: sending, to a first producer network function, a first service request comprising information indicating a requested service and information identifying a second producer network function that is unable to provide the requested service; and receiving, from the first producer network function, a service response to the first service request.

The instructions, when executed by the apparatus, may further cause the apparatus to perform: sending, to the second producer network function, a second service request comprising information indicating the requested service; determining that no response to the second service request has been received from the second producer network function within a certain time period; and sending the first service request to the first producer network function in response to determining that no response has been received to the second service request within the certain time period.

The instructions, when executed by the apparatus, may further cause the apparatus to perform: sending, to the second producer network function, a second service request comprising information indicating the requested service; receiving, from the second producer network function, a second service response rejecting the second service request; and sending the first service request to the first producer network function in response to receiving the second service response rejecting the second service request.

The instructions, when executed by the apparatus, may further cause the apparatus to perform: sending, to the second producer network function, a second service request comprising information indicating the requested service; receiving, from the second producer network function, a second service response comprising information indicating that the second service request is to be redirected to the first producer network function;

and sending the first service request to the first producer network function in response to receiving the second service response comprising information indicating that the second service request is to be redirected to the first producer network function.

The second service response may comprise information indicating a cause for redirection, and wherein the first service request further comprises the information indicating the cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The instructions, when executed by the apparatus, may further cause the apparatus to perform: determining, based on previously received information, that the second producer network function is unable to provide the requested service; and sending the first service request in response to determining that the second producer network function is unable to provide the requested service.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function; an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect, there is provided a computer readable medium comprising instructions which, when executed by an apparatus, cause the apparatus to perform at least the following: receiving, from a consumer network function, a first service request comprising information indicating a requested service and information identifying a second producer network function that is unable to provide the requested service; determining whether to provide the requested service; and based on the determining, sending, to the consumer network function, a service response to the first service request.

The first service request may further comprise information indicating that the first service request is a request that was transmitted or retransmitted to an alternative producer network function.

The first service request may further comprise information indicating that the second producer network function did not respond, rejected or redirected a second service request for the requested service.

The first service request may further comprise information indicating that the first service request is a redirection request, and wherein the first service request may further comprise information indicating a cause for redirection.

The information indicating the cause for redirection may comprise at least one of: information indicating that the second producer network function is overloaded; information indicating that the second producer network function is shutting down; or information indicating that another producer network function is owning a resource targeted by the second service request.

The instructions, when executed by the apparatus, may further cause the apparatus to perform: determining, based on the first service request, to refrain from redirecting the first service request and/or one or more further service requests for the requested service towards the second producer network function.

The instructions, when executed by the apparatus, may further cause the apparatus to perform: receiving the first service request and/or the one or more further service requests for the requested service; determining that the first service request and/or the one or more further service requests are to be redirected away from the first producer network function; and in response to determining to redirect the first service request and/or the one or more further service requests away from the first producer network function and determining to refrain from redirecting the first service request and/or the one or more further service requests towards the second producer network function, discovering one or more candidate producer network functions towards which the first service request and/or the one or more further service requests may be redirected, wherein the one or more candidate producer network functions excludes the second producer network function.

Discovering the one or more candidate producer network functions may comprise: sending, to a network repository function, a discovery request comprising information identifying the requested service and indicating that the second producer network function is to be excluded from a list of candidate producer network functions; and receiving, from the network repository function, a list of candidate producer network functions for providing the requested service, wherein the list of candidate producer network functions excludes the second producer network function.

The information indicating that the second producer network function is to be excluded from a list of candidate producer network functions may comprise at least one of: an identifier of the second producer network function; an identifier of a service instance of the second producer network function; an identifier of a set of producer network functions to which the second producer network function belongs; or an identifier of a set of service instances of the second producer network function.

The first producer network function and the second producer network function may be a same type of network function.

The first producer network function and the second producer network function may belong to a same network functions set or a same network function service instances set.

The information identifying the second producer network function that is unable to provide the requested service may comprise at least one of: an identifier of the second producer network function; an identifier of a service instance of the second producer network function;

an identifier of a set of producer network functions to which the second producer network function belongs; or an identifier of a set of service instances of the second producer network function.

The first service request may further comprise information indicating that the second producer network function has rejected a service request for the requested service due to the second producer network function being overloaded.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Some example embodiments will now be described, by way of non-limiting and illustrative example only, with reference to the accompanying Figures in which:

FIG. 1 shows a representation of a 5^{th} generation communication system;

FIG. 2 shows a representation of an apparatus for the communication system of FIG. 1 according to some example embodiments;

FIG. 3 shows a representation of an apparatus according to some example embodiments;

FIG. 4 shows a method/methods according to some examples;

FIG. 5 shows a signalling procedure according to some examples; and

FIG. 6 shows a schematic representation of an apparatus according to some examples.

### DETAILED DESCRIPTION

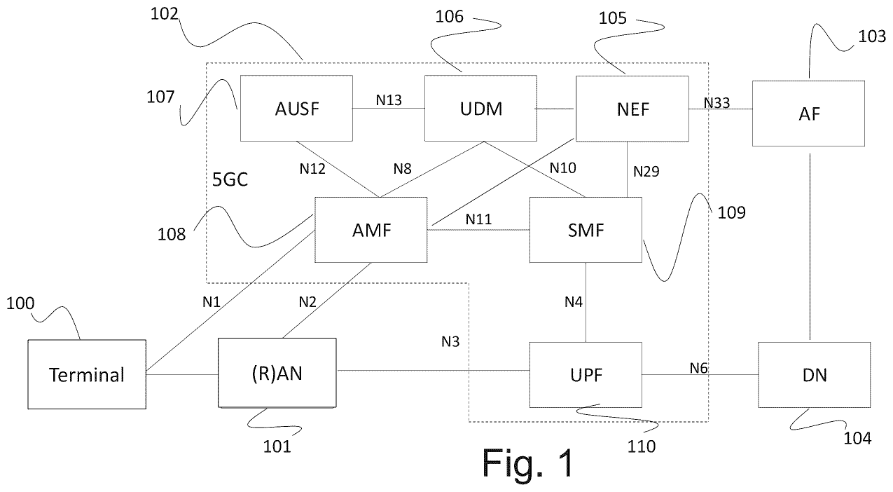

In the following various example embodiments are explained with reference to communication devices capable of communication with a communication system. Before explaining in detail the embodiments of the methods and apparatuses of the present disclosure, a 5th generation communication system (5GS), an access network and a core network (5GC) thereof, and communication devices are briefly explained with reference to FIGS. 1, 2 and 3.

FIG. 1 shows a schematic representation of a 5G communication system (5GS). The 5GS may comprise a user equipment (UE) or Terminal 100, an access network such as a 5G radio access network (5G-RAN) 101 or next generation radio access network (NG-RAN), a 5G core network 102, and one or more application functions 103. An application function 103 may be deployed in the 5GS as trusted application function or may be deployed or host on one or more application servers of the data network (DN) 104. Such application functions are untrusted application functions. The 5GS connects the UE to a data network the access network and the 5GC 102 (e.g., a UPF of the 5GC).

The 5G-RAN 101 may comprise one or more radio access nodes, such as gNodeB (gNB). A gNB may include one or more gNodeB (GNB) distributed units connected to one or more gNodeB (GNB) centralized units.

The 5GC may comprise the following network functions: Network Slice Selection Function (NSSF); Network Exposure Function (NEF) 105; Network Repository Function (NRF); Policy Control Function (PCF); Unified Data Management (UDM) 106; Application Function (AF) 103; Authentication Server Function (AUSF) 107; an Access and Mobility Management Function (AMF) 108; Session Management Function (SMF) 109; and a user plane function (UPF) 110. FIG. 1 also shows the various interfaces (N1, N2 etc.) that may be implemented between the various elements of the system.

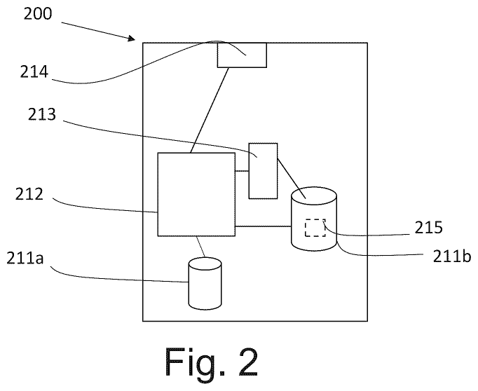

FIG. 2 illustrates an example of a control apparatus 200 for controlling a function of the access network (e.g., a 5G-RAN or the NG-RAN illustrated in FIG. 1) illustrated on FIG. 1.

The control apparatus 200 may comprise at least one random access memory (RAM) 211a, at least on read only memory (ROM) 211b, at least one processor 212, 213 and a network interface 214. The at least one processor 212, 213 may be coupled to the RAM 211a and the ROM 211b. The at least one processor 212, 213 may be configured to execute an appropriate software code 215. Execution of the software code 215 may for example may cause the apparatus to perform operations for controlling a function of the access network. The software code 215 may be stored in the ROM 211b. The control apparatus 200 may be interconnected with another control apparatus 200 for controlling another function of the 5G-RAN or the NG-RAN. In some embodiments, each function of the 5G-RAN or the NG-RAN is deployed or hosted on a control apparatus 200. In alternative embodiments, two or more functions of the 5G-RAN or the NG-RAN may share a control apparatus.

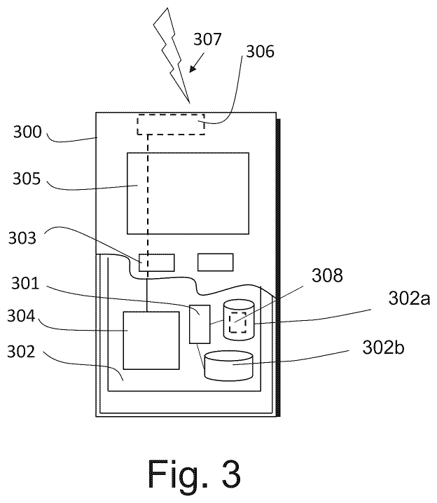

FIG. 3 illustrates an example of a communication device 300, such as the UE illustrated on FIG. 1. The communication device 300 may be provided by any device capable of sending and receiving radio signals. Non-limiting examples of a communication device 300 comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The communication device 300 may comprise a transceiver for transmitting and/or receiving, for example, wireless signals carrying communications, for example radio signals. The communications may be one or more of voice, electronic mail (email), text messages, multimedia data, machine data and so on.

The communication device 300 may receive wireless signals (e.g., radio signals) over an air or radio interface 307 via appropriate apparatus for receiving and may transmit wireless signals via appropriate apparatus for transmitting radio signals. In FIG. 3 transceiver is designated schematically by block 306. The transceiver 306 may comprise, for example, a radio part and associated antenna arrangement. The antenna arrangement may be arranged internally or externally to the mobile device and may comprise one or more antenna elements. The antenna arrangement may be a multi-input multi output (MIMO) antenna.

The communication device 300 may be provided with at least one processor 301, at least one memory ROM 302a, at least one RAM 302b and other possible components 303 for use in software and hardware aided execution of tasks it is designed to perform, including control of access to and communications with access networks (e.g., the 5G-RAN or NG-RAN illustrated in FIG. 1) and other communication devices. The at least one processor 301 is coupled to the RAM 302b and the ROM 302a. The at least one processor 301 may be configured to execute an appropriate software code 308. The software code 308 may for example allow to perform one or more operations of the communication device. The software code 308 may be stored in the ROM 302a.

The processor, the ROM, and the RAM, the transceiver and other circuitry of the communication device (e.g., a modem) can be provided on a circuit board, in chipsets, or in a system on chip. The circuit board, chipsets or system on chip is denoted by reference 304. The communication device 300 may optionally have a user interface such as keypad 305, touch sensitive screen or pad, combinations thereof or the like. Optionally one or more of a display, a speaker and a microphone may be provided depending on the type of communication device.

The 5GC has been defined as a Service Based Architecture (SBA), whereby NF service producers (pNFs—producer network functions) expose services that can be consumed by NF service consumers (cNFs—consumer network functions) using SBIs (Service-Based Interfaces). To request a service, a cNF may send a request message (e.g., a HTTP request) to a pNF, where the request message comprises the information necessary to invoke a particular service or service operation.

The pNF, upon receiving the request message, may determine whether to provide the requested service. In some cases, the request may be rejected by the pNF, for example because the pNF is unable to provide the requested service, or because the pNF is temporarily overloaded, or the pNF is scheduled to shut down. The pNF may indicate, in a response message to the cNF, that the cNF should perform pNF reselection towards an alternative pNF.

The cNF, either upon receiving the response message from the pNF indicating that the request has been rejected or redirected, or having not received a response message within a certain time period, may send a further request message to an alternative pNF. For example, when the response message from the pNF indicates that the cNF should perform pNF reselection towards an alternative pNF, the cNF may send a further request message to the alternative pNF. The further request message may comprise additional information indicating that the further request message is resent as a result of receiving an error or reject/redirect response—for example the additional information may indicate that the further request message relates to a reselection of an alternative NF; or that the further request message is a retransmission of an earlier request message (e.g., the request message has been sent but being rejected with a temporary failure or timeout).

It should be noted that there may be problems that arise with the SBA models. For example, in a scenario there are three pNFs (pNF1, pNF2 and pNF3) supporting the same service. A cNF sends a request to pNF1 and pNF1 rejected the request or redirected the request because pNF1 cannot provide the requested service. A redirection may for example be due to overload or administrative reasons (like pNF1 shutting down gracefully). The cNF therefore redirects the same request to pNF2 or pNF3.

As explained above, when the service request is rejected by pNF1 or redirected by pNF1 to pNF2, the cNF can resend the request to pNF2 including additional information that indicates that the request is resent to pNF2 as a result of receiving an error or a redirection response. However, the pNF2 does not get any information about the pNF1 identity which was originally selected by the cNF and which rejected or redirected the request.

Accordingly, the pNF2 may be unable to determine from which pNF (i.e., pNF1) the request was redirected or determine the pNF that rejected the request. That is to say, pNF2 may not determine from which pNF's redirection or because of which pNF's error pNF2 received that particular request from a cNF.

If the pNF2 is unable to provide the requested service (e.g., due to being overloaded), the pNF2 may attempt to redirect the request to the pNF1, thereby causing redirection loops and failure to provide the requested service. Furthermore, since the pNF2 is not aware that the pNF1 faces temporary or permanent issues, pNF2 may consider pNF1 for future redirections. That is to say, more generally, the pNF2 may not be aware of the status and health of the other pNFs, which may result in sub-optimal network performance. Debugging and trouble-shooting of such errors may be made more difficult, and optimizing the planning of the pNF resources and enabling the K8 orchestration to scale in and scale out more dynamically may also be made more difficult.

Some examples of the present disclosure address one or more of these issues. In some examples of the present disclosure, when a cNF sends a service request to a pNF, the cNF may include in the service request information identifying one or more pNFs that are unable to provide the requested service. In this way, the pNF receiving the service request may become aware of the status of other pNFs and may use this information to optimize network performance. For example, the pNF, based on the request, may refrain from redirecting one or more further service requests towards the one or more pNF identified in the service request as unable to provide the requested service, thereby avoiding a redirection loop.

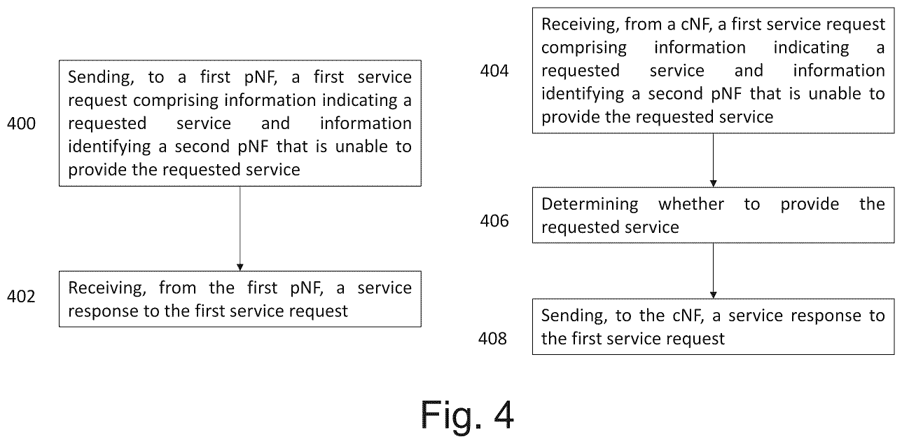

Reference is made to FIG. 4, which shows methods according to some examples.

At 400, a cNF sends, to a first pNF, a first service request comprising information indicating a requested service and information identifying a second pNF that is unable to provide the requested service.

At 402, the cNF receives, from the first pNF, a service response to the first service request.

At 404, a first pNF receives, from a cNF, a first service request comprising information indicating a requested service and information identifying a second pNF that is unable to provide the requested service.

At 406, the first pNF determines whether to provide the requested service.

At 408, the first pNF sends, to the cNF, a service response to the first service request.

The first pNF and the second pNF may be a same type of NF—for example the first pNF and second pNF may both be AMFs or SMFs etc. In some examples the first pNF and the second pNF may belong to a same NFs set or same NF service instances set. In some examples, the second pNF may be referred to as a sibling NF in the perspective of first pNF. In some examples, the information comprised in the first service request may identify/indicate one or more second pNFs.

In some examples the information identifying a second pNF that is unable to provide the requested service may comprise at least one of the following:
an identifier of the second pNF (e.g., NF-Instance);
an identifier of a service instance of the second pNF (e.g., NF-Set);
an identifier of a set of pNFs to which the second pNF belongs (e.g., NF-Service-Instance and/or NF-Instance); or an identifier of a set of service instances of the second pNF (e.g., NF-Service-Set).

Table 1 below provides examples of the supported scopes for OCI signalled by cNF in service request.

TABLE 1
examples of supported scopes for OCI signalled by cNF in service request

| Parameter | Value | OCI scope (i.e. OCI applies to) | Examples |
|---|---|---|---|
| NF-Instance | NF Instance ID | All services of the NF instance identified | NF-Instance: 54804518-4191-46b3- |
| | | by the NF Instance ID. | 955c-ac631f953ed8 |
| NF-Set | NF Set ID | All services of all NF instances of the NF | NF-Set: |
| | | set identified by the NF Set ID. | set1.udmset.5gc.mnc012.mcc345 |
| NF-Service- | NF Service | The service instance identified by the NF | NF-Service-Instance: serv1.smf1; |
| Instance (and | Instance ID (and | Service Instance ID and the NF instance | NF-Inst: 54804518-4191-46b3- |
| NF-Inst) | NF Instance ID) | Id (if available) or the last known NF | 955c-ac631f953ed8 |
| | | instance ID. | |
| NF-Service-Set | NF Service Set | All service instances of the NF service | NF-Service-Set: setxyz.snnsmf- |
| | ID | set identified by the NF service set ID. | pdusession.nfi54804518-4191- |
| | | | 46b3-955c- |
| | | | ac631f953ed8.5gc.mnc012.mcc345 |

In some examples the cNF may send, to the second pNF, a second service request comprising information indicating the requested service. The second service request may be sent to the second pNF before sending the first service request to the first pNF.

The cNF may, in some examples, send the first service request when no response has been received to the second service request within a certain time period. For example, the cNF may determine that no response has been received to the second request within the certain time period and send the first service request to the first pNF in response to determining that no response has been received to the second request within the certain time period.

In some examples the cNF may receive, from the second pNF, a second service response rejecting the second service request. The cNF may send the first service request to the first pNF in response to receiving the second service response rejecting the second service request.

In some examples the cNF may receive, from the second pNF, a second service response comprising information indicating that the second service request is to be redirected to the first pNF. The cNF may send the first service request to the first pNF in response to receiving the second service response redirecting the second service request.

In some examples the second service response may further comprise information indicating a cause for the second pNF rejecting or redirecting the second service request. The information indicating the cause for the second pNF rejecting or redirecting the second service request may for example comprise at least on of: information indicating that the second pNF is overloaded; that the second pNF is shutting down; or information indicating that another pNF is owning a resource targeted by the second service request. In some examples information indicating the cause for the second pNF rejecting or redirecting the second service request may be as defined in clause 5.2.3.2.9 of 3GPP TS 29.500.

In some examples the second service response may comprise a temporary redirect response or permanent redirect response. An example of the content of a redirection response message is provided below in table 2.

TABLE 2
example content of redirection message

| Attribute name | Data type | P | Cardinality | Description |
|---|---|---|---|---|
| cause | string | C | 0 . . . 1 | A machine-readable cause string, specific to |
| | | | | this occurrence of the redirection. |
| | | | | If the redirection is initiated by an SCP towards |
| | | | | another SCP, this IE may be present and set to |
| | | | | “SCP_REDIRECTION”. |
| | | | | If the redirection is initiated by an SEPP |
| | | | | towards another SEPP, this IE may be present |
| | | | | and set to “SEPP_REDIRECTION”. |
| targetScp | Uri | O | 0 . . . 1 | ApiRoot of the SCP towards which an HTTP |
| | | | | request is redirected (see clause 6.10.9 of |
| | | | | 3GPP TS 29.500 [25]). |
| targetSepp | Uri | O | 0 . . . 1 | ApiRoot of the SEPP towards which an HTTP |
| | | | | request is redirected (see clause 6.10.9 of |
| | | | | 3GPP TS 29.500 [25]). |

In some examples the first service request sent to the first pNF may comprise information associated with the second producer network function that is unable to provide the requested service. For example, the first service request may comprise the information indicating a cause for the second pNF being unable to provide the requested service. For example, the first service request may comprise information indicating that the second pNF did not respond, rejected, or redirected the second service request for the requested service. In some examples the first service request may further comprise information indicating that the first service request is a request that was retransmitted or redirected to an alternative pNF.

In some examples, the information comprised in the first service request may comprise at least one of the following:
Sibling NF instance ID (e.g., NF instance ID of the second pNF);
Sibling NF service instance ID (e.g., service instance of the second pNF);
Sibling NF set ID (e.g., set ID of the second pNF);
Sibling NF service set ID (e.g., service set ID of the second pNF);
Redirection Cause: The redirection cause may be received by the cNF from the second pNF in the second service response; or
Overload scope: When/if the redirection cause indicates “overloaded”, the overload scope may inform/indicate whether the request was rejected by second pNF due to overload of the NF service instance, the NF instance, the NF service set or NF set. In some examples, the Overload scope may be signaled from the second pNF to the cNF in a header (e.g., 3gpp-SBI-Oci header).

In some embodiments, the information may be comprised in an SBI header.

In some examples the first pNF may determine, based on the first service request, to refrain from redirecting the first service request and/or one or more further service requests towards the second pNF. In some examples, the first pNF may determine to refrain from redirecting the first service request and/or the one or more further service requests towards the second pNF for a certain duration. The determining may for example be based on the information identifying a second pNF that is unable to provide the requested service and information indicating a cause for the second pNF rejecting or redirecting the second service request (if such information is included in the first service request).

In some examples, the first pNF may receive from the cNFs and/or one or more further cNFs, one or more further service requests for the requested service. The first pNF may determine that the first service request and/or the one or more further service requests need to be redirected away from the first pNF. In response to determining to redirect the first service request and/or the one or more further service requests away from the first pNF and determining to refrain from redirecting the first service request and/or the one or more further service requests towards the second pNF, the first pNF may discover one or more candidate pNFs towards which the first service request and/or the one or more further service requests may be redirected. The one or more candidate pNFs may exclude the second pNF.

For example, the first pNF may send, to a network repository function, a discovery request comprising information identifying the requested service and indicating that the second pNF is to be excluded from a list of candidate producer network functions. The first pNF may then receive, from the network repository function, a list of candidate pNFs for providing the requested service, wherein the list of candidate pNFs excludes the second pNF.

The information identifying/indicating that the second pNF is to be excluded from a list of candidate pNFs may comprise at least one of:
an identifier of the second pNF;
an identifier of a service instance of the second pNF;
an identifier of a set of pNFs to which the second pNF belongs; or
an identifier of a set of service instances of the second pNF.

Table 3 below provides example definitions of the content of the discovery request that may be sent from the first pNF to the network repository function:

TABLE 3
example definitions of content of discovery request

| Attribute | | | | | |
|---|---|---|---|---|---|
| name | Data type | P | Cardinality | Description | Applicability |
| exclude- | array(NfInstanceId) | O | 1 . .. N | If included, this IE may indicate the | Query- |
| nfinst-list | | | | list of NF instances that should not | SBIProtoc17- |
| | | | | be returned in the NF Discovery | Ext1 |
| | | | | response. | |
| exclude- | array(NfServiceInstance) | O | 1 . . . N | If included, this IE may indicate the | Query- |
| nfservinst- | | | | list of NF service instances that | SBIProtoc17- |
| list | | | | should not be returned in the NF | Ext1 |
| | | | | Discovery response. | |
| exclude- | array(NfServiceSetId) | O | 1 . . . N | If included, this IE may indicate the | Query- |
| nfserviceset- | | | | list of NF service sets of NF | SBIProtoc17- |
| list | | | | service instances that should not | Ext1 |
| | | | | be returned in the NF Discovery | |
| | | | | response. | |
| exclude- | array(NfSetId) | O | 1 . . . N | If included, this IE may indicate the | Query- |
| nfset-list | | | | list of NF sets of NF instances that | SBIProtoc17- |
| | | | | should not be returned in the NF | Ext1 |
| | | | | Discovery response. | |

In some examples, event records and key performance indicators (KPIs) may be generated based on the information comprised in the first service request. The event records and KPIs may be used to scale in and scale out the corresponding pNF Type, and/or in debugging and trouble-shooting operations. For example, when a certain pNF type is sending a larger than expected number of redirect/rejections to service requests (which may be indicated in the first service requests), it may be determined to increase the number of that type of pNF.

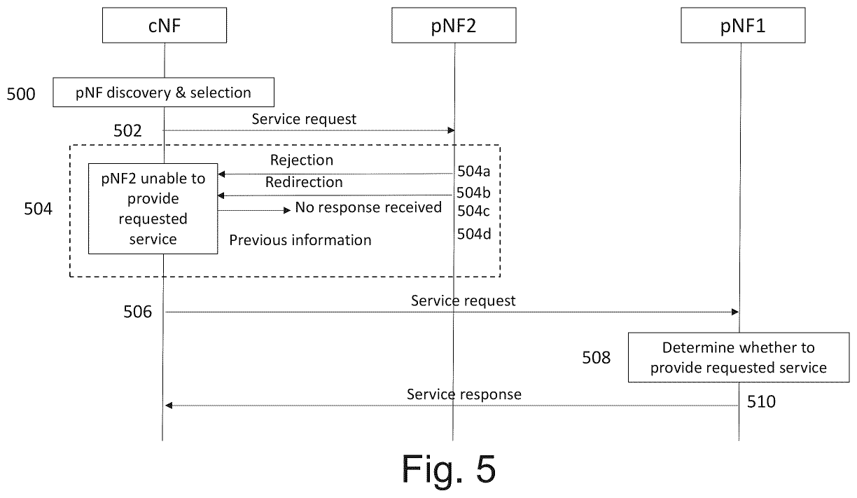

Reference is made to FIG. 5, which shows a signalling procedure according to some examples.

At 500, the cNF discovers one or more pNFs towards which to send a service request for a service, and selects one of those pNFs. In the example of FIG. 5, the cNF discovers pNF1 and pNF2, and selects pNF2.

At 502, the cNF sends a second service request to pNF2. The second service request may be as described previously.

At 504, the cNF may determine that pNF2 is unable to provide the requested service. As described previously, this may be based on:
determining that no response has been received to the second request within the certain time period (depicted at 504a);
receiving a second service response from pNF2 rejecting the second service request (depicted at 504b) or redirecting the second service request towards pNF1 (depicted at 504c); or
previously received information (e.g., a previously received service response from pNF2), the cNF may determine that pNF2 is unable to provide the requested service (depicted at 504d).

At 506, the cNF sends a first service request to pNF1. The first service request is as described previously. That is to say, the first service request comprises the information identifying the second pNF that is unable to provide the requested service, i.e. information identifying pNF2.

In some embodiments, the cNF sends the first service request to the pNF1 if/when:
(determining that) no response has been received to the second request within the certain time period;
receiving a second service response from pNF2 rejecting the second service request or redirecting the second service request towards pNF1; or
(determining that) pNF2 is unable to provide the requested service (e.g., based on previously received information).

At 508, the pNF1 determines whether to provide the requested service.

At 510, based on the determination at 508, the pNF1 sends a service response to the first service request to the cNF.

Several non-limiting examples of information comprised in the first service request (3gpp-Sbi-Request-Info) are provided below by way of example only to illustrate concepts of the present disclosure further.
EXAMPLE 1: For a request retransmitted to pNF1 due to the rejection by the original target pNF2 with a temporary rejection cause:
   3gpp-Sbi-Request-Info: retrans=true; redirect=true; reason=temporary-rejection-cause; receivedrejectioncause=INSUFFICIENT_RESOURCES; NF-instance: <pNF2 NF instance ID>; NF-service-instance: <pNF2 NF service instance ID>
EXAMPLE 2: For a request sent towards an alternative NF due to the original target NF (pNF2) not reachable:
   3gpp-Sbi-Request-Info: redirect=true; reason=unreachable; NF-instance: <pNF2 NF instance ID>; NF-service-instance: <pNF2 NF service instance ID>;
EXAMPLE 3: For a request sent towards an alternative NF due to the original target NF (pNF2) redirecting the request for some specific reason:
   3gpp-Sbi-Request-Info: redirect=true; reason=3xx-redirect; NF-instance: <pNF2 NF instance ID>; NF-service-instance: <pNF2 NF service instance ID>; redirection-cause: <cause information>
EXAMPLE 4: For a request sent towards an alternative NF due to the original target NF (pNF2) being overloaded:
   3gpp-Sbi-Request-Info: redirect=true; reason=overloaded; NF-instance: <pNF2 NF instance ID>; NF-service-instance: <pNF2 NF service instance ID>; overload-scope: <overload scope e.g. indicating overload of pNF2 service instance>

Examples have been described in which a cNF sends, to a first pNF, a service request for a requested service, where the service request comprises information indicating a second pNF that is unable to provide the requested service. This helps optimize the functionality of the network, for example by enabling the first pNF to refrain from redirecting service requests for that service towards the second pNF.

In some examples there is provided an apparatus comprising means for: sending, to a first producer network function, a first service request comprising information indicating a requested service and information identifying a second producer network function that is unable to provide the requested service; and receiving, from the first producer network function, a service response to the first service request.

In some examples there is provided an apparatus comprising at least one processor and at least one memory storing instructions that, when executed by the at least one processor, cause the apparatus at least to: send, to a first producer network function, a first service request comprising information indicating a requested service and information identifying a second producer network function that is unable to provide the requested service; and receive, from the first producer network function, a service response to the first service request.

In some examples the apparatus is or comprises a consumer NF. In the present disclosure, the apparatus being/comprising a consumer NF refers to an apparatus/device configured to provide/perform at least part of functionalities of the consumer NF.

In some examples there is provided an apparatus comprising means for: receiving, from a consumer network function, a first service request comprising information indicating a requested service and information identifying a second producer network function that is unable to provide the requested service; determining whether to provide the requested service; and based on the determining, sending, to the consumer network function, a service response to the first service request.

In some examples there is provided an apparatus comprising at least one processor and at least one memory storing instructions that, when executed by the at least one processor, cause the apparatus at least to: receive, from a consumer network function, a first service request comprising information indicating a requested service and information identifying a second producer network function that is unable to provide the requested service; determine whether to provide the requested service; and send, to the consumer network function, a service response to the first service request.

In some examples the apparatus is or comprises a producer NF. In the present disclosure, the apparatus being/comprising a producer NF refers to an apparatus/device configured to provide/perform at least part of functionalities of the producer NF.

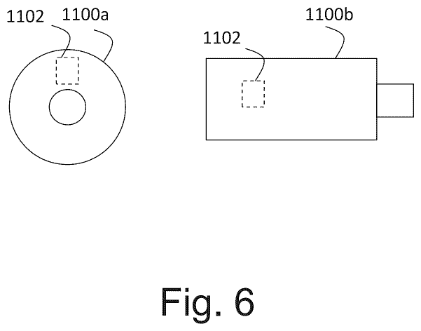

FIG. 6 shows a schematic representation of non-volatile memory media 1100a (e.g., computer disc (CD) or digital versatile disc (DVD)) and 1100b (e.g., universal serial bus (USB) memory stick) storing instructions and/or parameters 1102 which when executed by a processor allow the processor to perform one or more of the steps of the method of FIG. 4.

It is understood that references in the above to various network functions (e.g., to an AMF, an SMF, TNF etc.) may comprise apparatus that perform at least some of the functionality associated with those network functions. Further, an apparatus comprising a network function may comprise a virtual network function instance of that network function.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used herein, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the FIG.s may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Various example embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various example embodiments of the disclosure is set out by the independent claims. The example embodiments and features thereof, if any, described in this disclosure that do not fall under the scope of the independent claims are to be interpreted as examples useful for understanding various example embodiments of the disclosure.

The foregoing description has provided, by way of non-limiting and illustrative examples, a full and informative description of the various example embodiments of this disclosure. However, various modifications and adaptations may become apparent to those skilled in the relevant arts in view of the foregoing description, when read in conjunction with the accompanying drawings and the claims. However, all such and similar modifications of the teachings will still fall within the various example embodiments of the disclosure as set forth in the claims. By way of non-limiting and illustrative example, there is a further example embodiment comprising a combination of one or more example embodiments with any of the other example embodiments previously discussed.

1. An apparatus comprising at least one processor and at least one memory storing instructions for a consumer network function which, when executed by the at least one processor, cause the apparatus at least to:
send, to a first producer network function, a first service request comprising information indicating a requested service;
receive, from the first producer network function, a first service response comprising information indicating that the first service request is to be redirected to a second producer network function;
send, to the second producer network function, a second service request based on receiving the first service response, wherein the second service request comprises information indicating the requested service and information identifying the first producer network function that is unable to provide the requested service; and
receive, from the second producer network function, a second service response to the second service request.

2. The apparatus of claim 1, wherein the second service request further comprises information indicating that the first service request is a request that was transmitted or retransmitted to an alternative producer network function.

3. The apparatus of claim 1, wherein the second service request further comprises information indicating that the first producer network function redirected the first service request for the requested service.

4. The apparatus of claim 1, wherein the first service response comprises information indicating a cause for redirection, and wherein the second service request further comprises the information indicating the cause for redirection.

5. The apparatus of claim 4, wherein the information indicating the cause for redirection comprises at least one of:
information indicating that the first producer network function is overloaded;
information indicating that the first producer network function is shutting down; or
information indicating that another producer network function is owning a resource targeted by the first service request.

6. An apparatus comprising at least one processor and at least one memory storing instructions for a second producer network function which, when executed by the at least one processor, cause the apparatus at least to:
receive, from a consumer network function, a second service request comprising information indicating a requested service and information identifying a first producer network function that is unable to provide the requested service;
determine whether to provide the requested service; and
based on the determining, send, to the consumer network function, a second service response to the second service request.

7. The apparatus of claim 6, wherein the second service request further comprises information indicating that the first service request is a request that was transmitted or retransmitted to an alternative producer network function.

8. The apparatus of claim 6, wherein the second service request further comprises information indicating that the first producer network function redirected a first service request for the requested service.

9. The apparatus of claim 6, wherein the second service request further comprises information indicating a cause for redirection.

10. The apparatus of claim 9, wherein the information indicating the cause for redirection comprises at least one of:
information indicating that the first producer network function is overloaded;
information indicating that the first producer network function is shutting down; or
information indicating that another producer network function is owning a resource targeted by the second service request.

11. The apparatus of claim 6, wherein the apparatus is further caused to:
refrain, based on the first service request, from redirecting the second service request or one or more further service requests for the requested service towards the first producer network function.

12. The apparatus of claim 11, wherein the apparatus is further caused to
receive the one or more further service requests for the requested service;
determine that the one or more further service requests are to be redirected away from the second producer network function; and
in response to determining to redirect the one or more further service requests away from the second producer network function and refraining from redirecting the one or more further service requests towards the second producer network function, discover one or more candidate producer network functions towards which the one or more further service requests may be redirected, wherein the one or more candidate producer network functions excludes the first producer network function.

13. The apparatus of claim 12, wherein discover the one or more candidate producer network functions comprises:
sending, to a network repository function, a discovery request comprising information identifying the requested service and indicating that the first producer network function is to be excluded from a list of candidate producer network functions; and
receiving, from the network repository function, a list of candidate producer network functions for providing the requested service, wherein the list of candidate producer network functions excludes the first producer network function.

14. The apparatus of claim 6, wherein the first producer network function and the second producer network function are a same type of network function.

15. The apparatus of claim 6, wherein the first producer network function and the second producer network function belong to a same network functions set or a same network function service instances set.

16. A method for a consumer network function, the method comprising:
sending, to a first producer network function, a first service request comprising information indicating a requested service;
receiving, from the first producer network function, a first service response comprising information indicating that the first service request is to be redirected to a second producer network function;
sending, to the second producer network function, a second service request based on receiving the first service response, wherein the second service request comprises information indicating the requested service and information identifying the first producer network function that is unable to provide the requested service; and
receiving, from the second producer network function, a second service response to the second service request.

17. The method of claim 16, wherein the second service request further comprises information indicating that the first service request is a request that was transmitted or retransmitted to an alternative producer network function.

18. The method of claim 16, wherein the second service request further comprises information indicating that the first producer network function redirected the first service request for the requested service.

19. The method of claim 16, wherein the first service response comprises information indicating a cause for redirection, and wherein the second service request further comprises the information indicating the cause for redirection.

20. The method of claim 16, wherein the information indicating the cause for redirection comprises at least one of:
information indicating that the first producer network function is overloaded;
information indicating that the first producer network function is shutting down; or
information indicating that another producer network function is owning a resource targeted by the first service request.
